(19) United States
(12) Patent Application Publication
(10) Pub. No.: US 2009/0217537 A1
(43) Pub. Date: Sep. 3, 2009

(54) Novel advanced materials blades and cutting tools

(76) Inventors: Leo Spitz Macdonald, Slatington, PA (US); Andrew Garth Bentley, Potsdam, NY (US)

Correspondence Address: Leo Macdonald, 2952 Rockdale Rd, Slatington, PA, 18080, US

(21) Appl. No.: 12/072,992

(22) Filed: Feb. 29, 2008

(51) Int. Cl. B26B 21/58; B21K 11/02

(52) U.S. Cl. 30/350; 76/104.1

(57) ABSTRACT

A novel advanced materials blade has been invented. It is intended for use by professionals and other people who desire a high quality blade or other cutting tool. It offers many advantages, having an extraordinarily durable and long lasting edge and being tarnish free. The blade is composed of a superalloy from the cobalt-chrome-nickel ternary phase diagram; said blade having a body, and edge, and a tang. In an embodiment the blade edge is transmuted into a metallo-ceramic graded material using carbon to form carbides (-MC). These carbides are diffusion integrated into the superalloy, making this blade a graded material. In an additional embodiment the blase edge is atomically modified causing the excess carbon to form tetrahedral carbon (diamond). Applications of this novel advanced materials blade include professional chefs knifes, ice axe tools, and wood cutting axes.

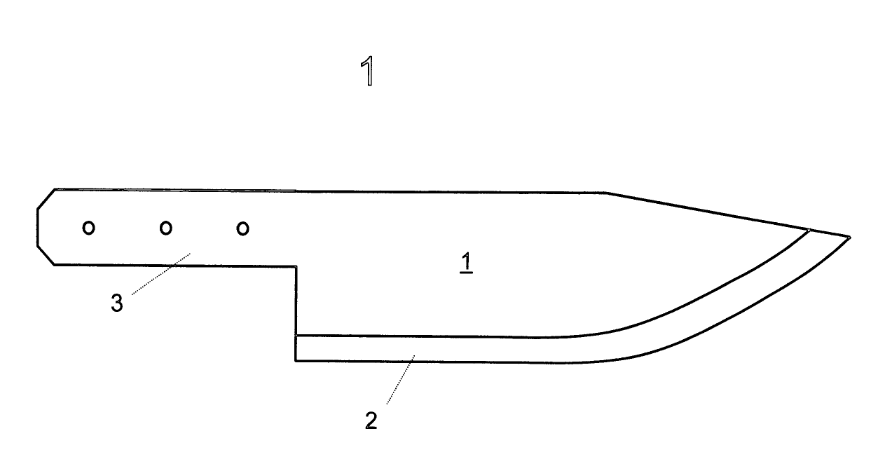

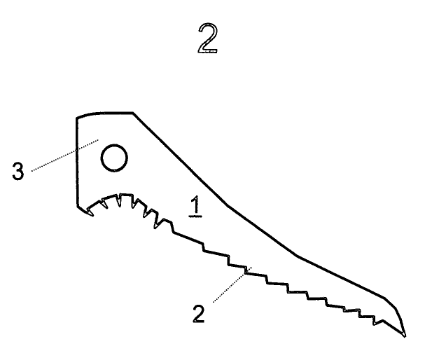

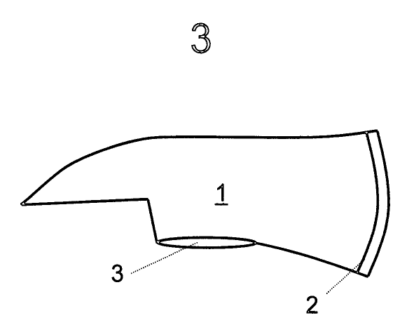

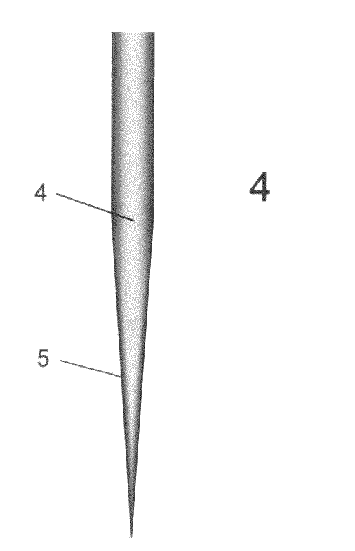

### TECHNICAL FIELD

This invention is directed to the art of manufacturing cutting tools including blades and suggested to be placed in class 30 cutlery, sub-class 345 materials.

### REFERENCES

US Patent documents incorporate by reference

| US PTO # | Inventor | Date |
|---|---|---|
| 2634499 | Bowes | April 1953 |
| 2776471 | McKenzie | October 1956 |
| 3190047 | Villalobos | June 1965 |
| 3496973 | Ballard | February 1970 |
| 3914473 | Hale | October 1975 |
| 4709480 | Takigawa et al | December 1987 |
| 5351588 | Penoza | October 1994 |
| 5787773 | Penoza | August 1998 |
| 5937466 | Brainerd et al | August 1999 |
| 5996235 | Brainerd | December 1999 |
| 6067784 | Jordan | May 2000 |
| 6192591 | Hellstern | February 2001 |
| 6207294 | Rutter | March 2001 |
| 6861161 | Ponemayr et al | March 2005 |
| 6868698 | Gruber et al | March 2005 |
| 6944955 | Skrivan et al | September 2005 |
| 7140113 | King et al | November 2006 |
| 7309373 | Anderson | December 2007 |

### BACKGROUND OF THE INVENTION

Professionals use cutlery for a variety of purposes. Cutlery is defined by Webster's Dictionary as cutting instruments collectively, including knives and other utensils. Examples of cutlery include a chef knife; a large chopping tool for cutting foods, an axe; a tool with a handle having a sharpened head located at one end of the handle, and a saw; a tool or device for cutting, typically having serrated blade and a handle. Fine cutlery is separated from ordinary cutlery by the greater workmanship put into the piece of cutlery as well as the quality of the materials used in the manufacture of the cutlery.

Chefs knives are used in a manner in which the duration of the sharp edge is of utmost importance. The knife is used to cut a variety of foods, for many hours every day, and should be able to perform without resharpening for several weeks. This requires that a knife edge resist dulling for long periods of usage. Unfortunately, once dull, a chef knife is quite useless as many foods have soft structures surrounded by hard shells or skins that a dull knife will smush and smash rather than cut. It would be welcome in the art if a new blade was developed that was more resistant to long term wear while chopping food in a commercial kitchen.

Ice axes are used to cut into ice sheets and vertical surfaces as a climber ascends the ice surface. In recent trends, the increased popularity of mixed type climbing, in which climbers ascend vertical structures composed of both ice and rock, had led to a need for better blades. The old blades that are typically steel or stainless steel are not able to withstand being driven into rock cracks and dirt as well as ice, without severe dulling and damage to the cutting edges of the blade. It would be welcome in the art if a new blade was developed that was more resilient to degradation by repeated hammering into ice-rock interfaces.

Wood axes are used to chop trees and split cylindrical logs. The blade of a wood axe is most often made of steel. It has always been a problem for those instances of use in which the strike of the wood axe misses the wood and contacts the ground, hitting dirt or rocks, thereby dulling the blade. Titanium is sometimes used, but upon examination of the materials properties, this yields only a weight savings benefit, not an increased hardness nor strength benefit. In extreme situations, a wood axe is used to chop through the roof of a burning building as demonstrated by multiple fire departments across the United States. Chopping through asphalt shingles coated with abrasive roofing granules causes a wood axe to dull rapidly. It would be welcome in the art if a new blade was developed that was more resilient to degradation by repeated chopping of dirt, rocks, roofing materials and other hard structural materials.

Hand operated cutlery has two major components, the handle and the blade. These two parts are manufactured of materials, said materials being formed typically of elements, said elements joined to form alloys, plastics, ceramics, and other materials. The blade is the more important of the two components in that the work being performed can only be done by the blade. The handle exists only as a vessel for allowing the human hand to hold and guide the blade to the appropriate task. As such the blade, as manufactured, possesses several qualities that make it useful for the task it is designed for, such as points, edges, thick and thin sections, coatings, flutes, grooves, holes, and the like. The shape is rather dictated by the task at hand. The materials used are dictated by the required functionality of the blade, these functions include durability, edge retention, hardness, toughness, ductility, corrosion resistance, and cost.

The use of stone, iron (Fe), steels (Fe, C) and stainless steels (Fe, Cr, C) as a material for cutlery blades are well known in the art. The use of plastics (C, H, N, S), wood, bone, stone, rubbers, and various metals as materials for the handle are well known in the art. The current materials used for blade components offers various advantages and disadvantages. The stainless steel blade resists the action of oxidation and is thereby prevented from tarnishing or rusting. Unfortunately, the addition of chromium reduces the hardness of the metal, thereby leading to reduced sharp edge life, and requires that the blade is frequently sharpened. The steel blades maintain the sharp edge for a longer time, but steel blades are quite prone to rust and discoloration, especially when used to cut certain acidic or basic foods, or exposed to weather. Most blades in current use are either stainless steel or steel

The use of ceramics as a blade material including tungsten carbide (WC) coatings have been disclosed in previous teachings. Typically these ceramics are particles bonded in a matrix of metal such as nickel or cobalt. These particles are not integral with the blade and have a tendency to fall out. Once the hard particle have fallen out, the tool becomes dull and far less effective. Additionally the use of particles prevents resharpening of the cutlery piece because there is no way to restore the particles. The use of zirconium oxide monolithic blades have been disclosed in previous teachings. This material is extremely hard, but has very little toughness. It will cut in a straight line for a long time, but any attempt to flex or pry with the blade will cause instant catastrophic failure.

Based on the above descriptions of the current state of the art, it appears that it would be welcome if a blade was invented that would maintain a sharp edge, exhibit high hardness and increased toughness while being repeatedly abused by forceful striking into the ground, rocks, dirt, and long term use. In addition it should be resistant to tarnishing, and resharpenable.

### BRIEF SUMMARY OF THE INVENTION

A novel advance materials blade has been invented that maintains a sharp edge, exhibits high hardness and increased toughness, is resistant to tarnishing and is resharpenable. This blade is composed of a combination of advanced materials. This new blade utilizes a superalloy for the body of the blade. Said superalloy is a very hard and very strong alloy of metal, typically comprising the elements cobalt, chromium, nickel, as well as other minor constituents including molybdenum, tungsten, vanadium, niobium, and carbon. In order to resist tarnishing and oxidation, the handle of this new knife utilizes precious metals in whole or in part as a coating, typically comprising the noble metals, gold, iridium, or platinum. In an additional embodiment, the blade is subjected to a diffusion carburization such that the blade becomes a graded material. The outer surface is converted into a carbide which decreases gradually with depth, with the interior maintains the hardness and ductility of the superalloy. This results in a increased edge retention. If an excess of carbon is used, it may be further modified atomically to yield a tetrahedral carbon surface, increasing the hardness yet further and making the edge harder than any other known substance.

The object of this invention is to provide the professional user with a higher quality and longer lasting blade.

### BRIEF DESCRIPTION OF SEVERAL VIEWS OF THE DRAWING

Two modified forms of construction of the novel advanced materials blade are presented. These are to be construed as illustrative examples and not as any sort of limitation on the forms of the current invention. A person trained in the art is able to understand these descriptions and that a variety of possible forms are within the scope and coverage of this invention.

1-4 is a view of an embodiment of an advanced materials chefs knife blade.

2-4 is a view of an embodiment of an advanced materials ice axe blade.

3-4 is a view of an embodiment of an advanced materials demolition axe blade.

4-4 is a cross sectional view of the graded metallo-ceramic structure of a blade.

### DETAILED DESCRIPTION OF THE INVENTION

The current invention provides teachings of a more advanced set of materials and manufacturing methods for making the individual blade as components of a complete tool such as a knife, axe or other cutting tool as well as the necessary assembly to achieve a whole assembly that is superior to current cutting blades and tools. The current invention has many advantages that make it unique among cutting blades and tools.

These cutting tools are composed of a multiplicity of components and a method for assembling said components. These components include a blade and a handle, whilst said method of assembly being the process of attaching said handle onto said blade.

The blade is a generally planar form having two somewhat parallel surfaces creating the body. The body (1) is the component of the blade which gives strength and weight to the blade. The body is further defined by boundaries. These boundaries may be at a variety of angles and of a variety of shapes and delineate the blade in various directions. These boundaries may be curves, straight lines, ridged, diagonals, scalloped, and other shapes. One or more boundary is typically sharpened to give an edge (2) and is considered the primary or cutting edge. One sub-component of the body is the tang (3). The tang is utilized as an attachment area for the handle.

The material for the body is selected from a group of metal alloys that are known as superalloys. These alloys were developed for the jet engine and gas turbine industry and include such alloys as Haynes®, Inconel®, Rene®, Hastelloy®, Mar M®, Monel®, and other alpha-numerically designated alloys. These alloys are typically based on the metallurgy of the cobalt-chromium-nickel (Co—Cr—Ni) ternary phase diagram. All of these alloys use one metal as the basis of the alloy with varying amounts of the other two metals. Additional metals are added as stabilizers for the various phases and crystal structures that form during manufacturing. In an embodiment, the alloy selected is primarily a cobalt alloy having chromium, tungsten, manganese, nickel, and carbon in lesser amounts.

The body of the blade is formed by cutting flat metal plate into pieces that are approximately the desired size, but typically 0.2″ oversize. Due to the extremely hard nature of the materials used, exotic cutting processes are used as well. These cutting methods include wire-EDM, laser, plasma, water-jet, and others. The final shape is achieved through grinding the edges with an abrasive. This abrasive is typically mounted on a wheel, but may also be mounted on a motorized belt. After shaping, the blade is polished, again using abrasive. This abrasive may be mounted or loose.

The edge of the blade is formed through an abrasive removal process. The abrasive is typically mounted on a belt but may be on a wheel or other support. Said belt is mounted on a machine that has various supports and guides for the belt. Said supports and guides may be a variety of shapes including convex, concave, flat, curvilinear, exponentially curvaceous, parabolically curvaceous, and may be hyperbolically curvaceous. In an embodiment said guides are convex, flat, and parabolically curvaceous. Said blade is mounted on a support system that allows the application of the edge to the belt in a variety of angles and coincident planar forms. Cooling may be provided in the form of a water or other fluid spray.

Upon formation of the edge, additional finishing and polishing steps are often performed on the body of the blade. These steps utilize abrasives which may be mounted or loose, said abrasive applied with force to the blade to effect uniform material removal. The material of the blade is removed in successively lesser and lesser amounts, resulting in a successively smoother and flatter surface.

In an additional embodiment the blade is hardened through a heat treat recrystallization process. The blade is heated to solutionize the soluble phases and then cooled advantageously to induce very small crystals to grow uniformly through the structure.

In an additional embodiment, the blade is subject to a transmutation process utilizing the application of carbon powders in a high temperature furnace. The blade is packed into a vessel with the carbon powder and the entire assembly is heated to a temperature at which the carbon reacts with the metal atoms in the superalloy to form metal carbides. These carbides are diffusion integrated into the superalloy, making this blade a graded material which is considered to be a highly advanced material. This graded material has an interior (4) and an exterior (5). The interior retains the properties of the body, being metallic and therefore ductile. The exterior becomes changed into a much harder ceramic such as cobalt carbide, tungsten carbide, chrome carbide, and combinations thereof. The gradation across the cross section as shown in 3-3 gives this material its name. According to current research, this has not been done before in the art of blade making. This treatment results in a blade edge that is extraordinarily hardened, similar in hardness to a ceramic, while retaining much of the ductility of the underlying base superalloy, resulting in a truly superior edge having extreme durability and longevity.

In an additional embodiment the blade is hardened through a transmutation process utilizing chemical vapor deposition in high temperature furnaces. The blade is placed into a vessel and heated to a reaction temperature, typically in vacuum, at which time carbon vapors are introduced into the vessel. The carbon deposits and reacts with the metal atoms in the superalloy to form metal carbides. These carbides are diffusion integrated into the superalloy, making this blade a graded material.

In an additional embodiment, the carbon is applied in excess. Further heat treatment and surface modification of the atomic bonding may form other crystalline phases such as tetrahedral carbon. This process is currently unknown in the art of metal treating and knife making.

The blade incorporates a tang (3) which is utilized for attachment of a handle. The tang incorporates holes, grooves, and protrusions that facilitate the mounting of the handle.

The handles used for this novel advanced materials blade have been described in the art and may be in common use on other blades. The handle may be a cylindrical form that is divided in two parts through a plane along the length of the cylinder. This handle may be comprised of a variety of substances. Traditional materials may be used including wood, bone, plastics, composites, and metals.

The handle may be coated with additional substances to improve handling characteristics and sensation. In an embodiment this coating is a metal taken from a group of metals including platinum, iridium, palladium, and gold. Gold has long been known for its outstanding resistance to corrosion, its warmth, and its high coefficient of friction. These traits make it well suited to use as a handle coating. The handle may have additional coatings applied including clear lacquers and epoxies to preserve the handle from being scratched or marred. The handle may be then further modified by applying coatings for tactile effectiveness, scratch resistance, beauty, strength, and to enhance or impart other desirable properties.

When the blade has been completed, the tang is joined to the handle. This joining process may be accomplished through the use of pins that interlock the handle components through the holes in the tang. These pins may be attached by various processes including gluing, welding, soldering, brazing, forging, and isostatic pressing. In another embodiment said blade may be joined to the handle by screwing, bolting, or other mechanical fastening.

From the foregoing it will be understood that the blade as a whole and by sub-component, as well as the methodology of manufacture, embodying the present invention described above are well suited to provide the advantages set forth, and since many embodiments are possible for the type of blade, and use thereof, as the handle and assembly system described herein, all without departing from the scope of this invention, it is to be understood that all matter hereinbefore described and shown in the accompanying drawings is to be construed as illustrative and that in certain circumstances, some of the features of the present invention may be used without a corresponding use of other features, all without departing from the scope of this invention.

1. A novel advanced materials blade comprising:
a sharp edge;
a body;
a tang;
said blade being composed of a superalloy selected from the cobalt, chrome, nickel (Co—Cr—Ni) ternary phase diagram having smaller amounts of phase modifying elements such as molybdenum, tungsten, niobium, manganese, silicon, and carbon.

2. The blade as recited in claim 1, having a use as a chef knife, an ice axe blade, and/or a wood/demolition axe blade and having a shape including flat, curvaceous, serrated, pointed, hooked, multifaceted as necessary for proper function in said use.

3. The blade as recited in claim 1, having the edge of said blade transmuted into a graded metallo-ceramic material utilizing diffusion metal carbides as a hardening phase.

4. The edge as described in claim 2, in which excess carbon is further modified atomically into hard crystalline phases such as tetrahedral carbon.

5. A novel advanced materials knife manufacturing method comprising:
cutting a superalloy blade to shape including a tang and edge;
abrasively grinding and polishing the blade shape and edge;
forming a handle;
mounting said handle to said tang;
coating said handle with a precious metal resistant to corrosion.

6. The knife manufacturing method as recited in claim 4, including transmuting said superalloy blade into a graded metallo-ceramic material utilizing diffusion metal carbides as a hardening phase.

7. An edge modification method such that the transmutation detailed in claim 5 comprises the addition of excess carbon, and the atomic modification thereof in order to effect the formation of diamond crystals.
